(19) United States
(12) Patent Application Publication
(10) Pub. No.: US 2025/0159457 A1
(43) Pub. Date: May 15, 2025

(54) USER EQUIPMENT (UE) LOCATION ACQUISITION IN A CELLULAR NETWORK

(71) Applicant: DISH Wireless L.L.C., Englewood, CO (US)

(72) Inventors: Prakash Patel, Castle Rock, CO (US); Parthasarathi Tripathy, Highland Ranch, CO (US)

(21) Appl. No.: 18/509,084

(22) Filed: Nov. 14, 2023

(51) Int. Cl. H04W 8/04; H04W 4/14; H04W 8/12

(52) U.S. Cl. CPC H04W 8/04; H04W 4/14; H04W 8/12

(57) ABSTRACT

A cellular telecommunication system application server (AS), such as the short message service center (SMSC) or Multimedia Messaging Service Center (MMSC), obtains a cellular network subscriber UE location information from a Home Subscriber Server (HSS) of the cellular telecommunication system. The system determines whether the cellular network subscriber UE is roaming based on the UE location information obtained from the HSS. The system populates the location information obtained from the HSS into a call data record (CDR) of the UE and determines whether the cellular network subscriber UE is roaming based on the location information obtained from the HSS populated into the CDR. The system supports location-based services of the UE based on UE location information obtained from the HSS both while the UE is on a home cellular network and while the UE is roaming.

### BRIEF SUMMARY

A mobile network operator (MNO) of a standalone Fifth Generation (5G) mobile network may have multiple roaming partners it uses for its subscribers, especially when the home network of the 5G MNO currently has limited coverage. There may also be a business requirement where the MNO must provide location information for every messaging transaction (e.g., for short message service (SMS) messages, Multimedia Messaging Service (MMS) messages, etc.). For example, the location information is used to determine billing for the messages. In particular, there may be different billing levels for SMS and MMS messaging while the subscriber is roaming compared to when they are on their home network. Thus, it becomes important to for the MNO to determine the user equipment (UE) location and whether the UE is roaming or on the home network when messaging occurs in order to calculate how many messages are sent when the subscriber is on the home network and how many are sent when the subscriber is roaming. Traditionally, obtaining such location information while the subscriber is roaming involves a large number of network hops within the cellular telecommunications network, which results in additional network traffic, delay, computing resource and network congestion.

In order to address the above technical problems, disclosed herein is a system for UE location acquisition in a cellular network that reduces the number of network hops in such scenarios. In an example embodiment, a cellular telecommunication system application server (AS), such as the short message service center (SMSC) or Multimedia Messaging Service Center (MMSC), electronically obtains a cellular network subscriber UE location information from a Home Subscriber Server (HSS) of the cellular telecommunication system. The system determines whether the cellular network subscriber UE is roaming based on the UE location information obtained from the HSS. The system populates the location information obtained from the HSS into a call data record (CDR) of the UE and determines whether the cellular network subscriber UE is roaming based on the location information obtained from the HSS populated into the CDR. The system electronically supports location-based services of the UE based on UE location information obtained from the HSS both while the UE is on a home cellular network and while the UE is roaming. In particular, the system performs analytics on the UE location information obtained from the HSS. This is performed in order to determine how many messages are sent to and from the UE over a cellular home network of the UE, determine how many messages are sent to and from the UE over one or more particular cellular networks of roaming partners, and identify the particular cellular networks of roaming partners over which messages are being sent to and from the UE. Thus, the AS is able to obtain the UE's 5G/Fourth Generation (4G) location through the HSS in order to support the UE's location-based services which will facilitate the mobile network operator billing requirements while the UE is roaming.

### BRIEF DESCRIPTION OF THE DRAWINGS

FIG. 1A is an example cellular network in which embodiments of UE location acquisition may be implemented.

FIG. 1B is a sequence diagram showing an example sequence of operations for a user equipment (UE) location acquisition mechanism for a 5G subscriber in accordance with embodiments described herein.

FIG. 2 is a sequence diagram showing an example sequence of operations for a user equipment (UE) location acquisition mechanism for a roaming 5G subscriber in accordance with embodiments described herein.

FIG. 3 illustrates a logical flow diagram showing an example embodiment of a process for UE location acquisition in a cellular network in accordance with embodiments described herein.

FIG. 4 illustrates a logical flow diagram showing an example embodiment of a process for determining whether the cellular network subscriber UE is roaming based on the UE location information obtained from the HSS in accordance with embodiments described herein.

FIG. 5 illustrates a logical flow diagram showing an example embodiment of a process for determining how many messages are sent to and from the UE while roaming and not roaming in accordance with embodiments described herein.

FIG. 6 illustrates a logical flow diagram showing an example embodiment of a process for facilitating mobile network operator billing for messaging based on whether the UE is roaming in accordance with embodiments described herein.

FIG. 7 shows a system diagram that describes an example implementation of computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

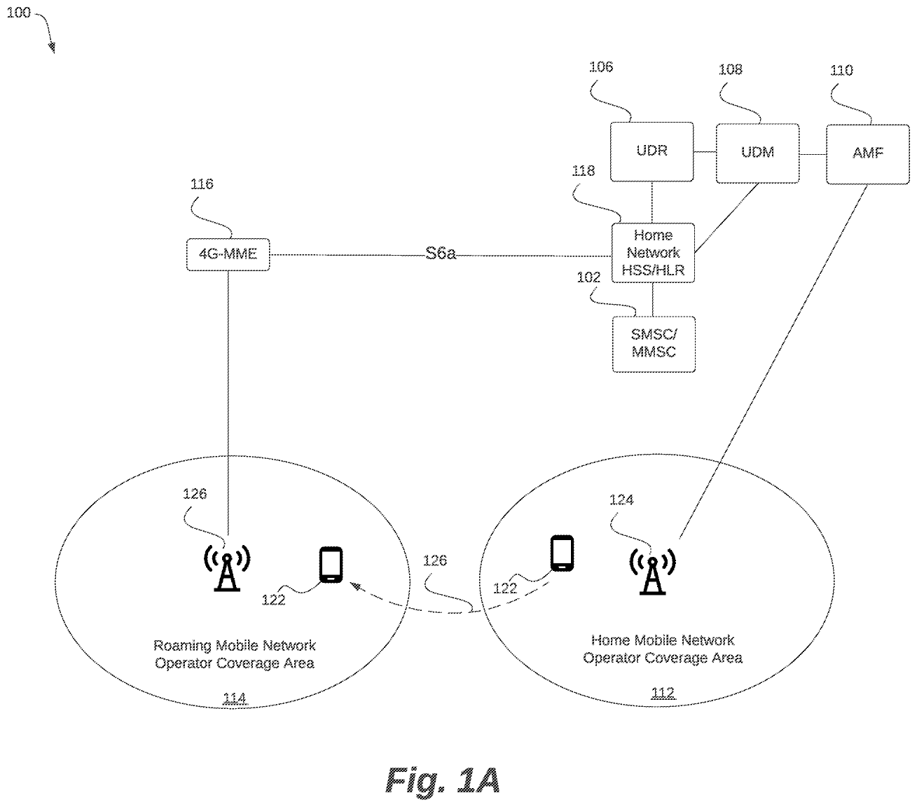

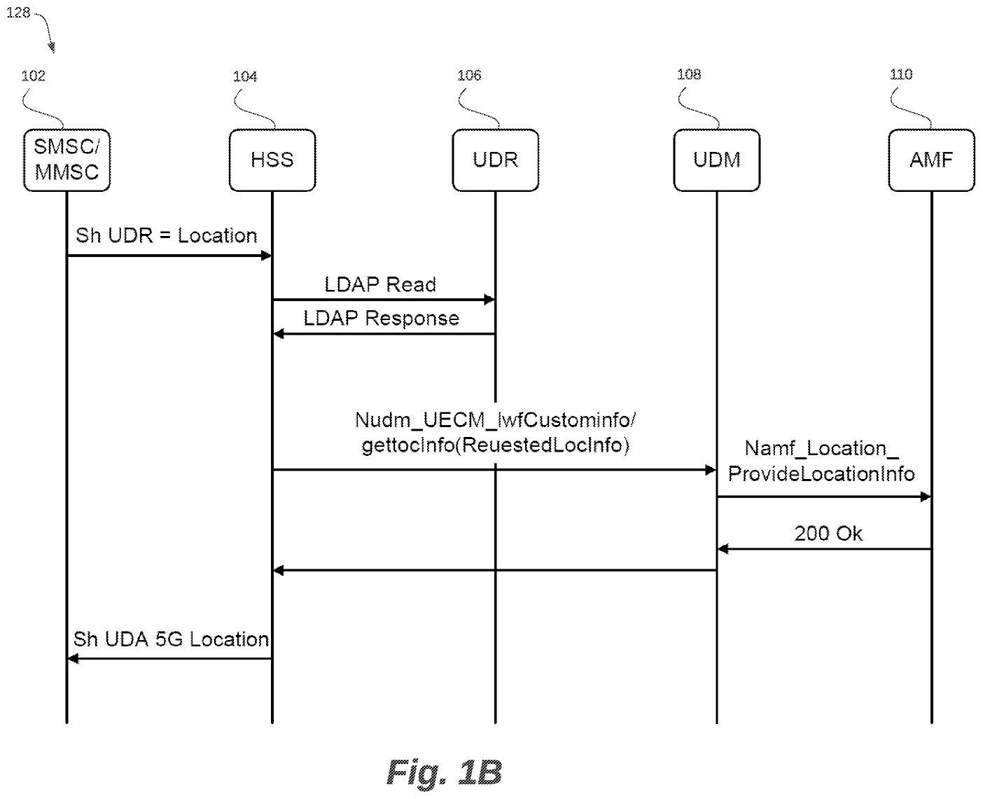

FIG. 1A is an example cellular network 100 in which embodiments of UE location acquisition may be implemented.

Shown in cellular network 100 is a home mobile network operator coverage area 112. In an example embodiment, the home mobile network operator coverage area 112 may be a cellular network coverage area of a mobile network of a mobile network operator to which user equipment (UE) 122 is subscribed as its home network. Cellular base station 124 (which may also be referred to as a cell site, cell phone tower, cell base tower, or cellular base station) is a cellular-enabled mobile device site where antennas and electronic communications equipment are placed (typically on a radio mast, tower, or other raised structure) to create a cell, or adjacent cells, in the home mobile network operator coverage area 112 of cellular network 100. There may be multiple base stations that provide the home mobile network operator coverage area 112, and base station 124 is provide as an example of one such base station.

UE 122 (e.g., a cellular telephone, smartphone, cellular-enabled tablet device, Internet-of-Tings (IoT) device, other cellular enabled computing device, etc.) communicates with the cellular network 100 by radio waves through a local antenna at cellular base station 124. The home mobile network operator coverage area 112 in which service is provided is divided into a mosaic of small geographical areas called “cells”, each served by a separate low power multichannel transceiver and antenna at a respective base station, such as base station 124. All the UEs within a cell communicate with the system through that cell's antenna, on separate frequency channels assigned by the base station from a common pool of frequencies used by the system.

The purpose of cellular organization is to conserve radio bandwidth by frequency reuse; the low power radio signals used within each cell do not travel far beyond the cell, so the radio channels can be reused in geographically separated cells. When a mobile user moves from one cell to another, their UE is automatically “handed off” to the new cell's antenna, and assigned a new set of frequencies, and subsequently communicates with this antenna. This background handoff process is imperceptible to the user and can occur in the middle of a phone call without any service interruption. Each UE, such as UE 122, may have an automated full duplex digital transceiver and communicates with the cell antenna over two digital radio channels in the LHE or microwave band, one for each direction of the bidirectional conversation, plus a control channel which handles registering the phone with the network, dialing, and the handoff process.

In various embodiments, the first mobile network operator coverage area 112 may be a coverage area of a Fight Generation New Radio (5G NR) standalone (SA) wireless network (5G SA). A 5G SA network uses a 5G core, which is the back-end system that then connects to the wider world of the internet, and provides access to computing and workload capabilities.

5G provides a broad range of wireless services delivered to the end user across multiple access platforms and multi-layer networks. 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible and virtual RAN with interfaces creating additional data access points.

5G network functions may be completely software-based and designed as cloud-native, meaning that they're agnostic to the underlying cloud infrastructure, allowing higher deployment, agility and flexibility. With the advent of 5G, industry experts defined how the 5G core (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations.

The 5G architecture is based on what is called a Service-Based Architecture (SBA), which implements IT network principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility, provides open interfaces and open source development, ultimately to ease the deployment of new features and technology with scale. The O-RAN ALLIANCE objective is to allow multi-vendor deployment with off-the shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

The 5G New Radio (5G NR) RAN comprises of a set of radio base stations (each known as Next Generation Node B (gNb)) connected to the 5G core (5GC) and to each other. In an example embodiment, base station 124 may be or represent a gNB. The gNb incorporates three main functional modules: the Centralized Unit (CU), the distributed Unit (DU), and the Radio Unit (RU) (not shown), which can be deployed in multiple combinations. This 5G RAN architecture is described in 3GPP TS 38.401 V16.8.0 (2021-12). Each network function (NF) of the 5G RAN and 5G core is formed by a combination of small pieces of software code called as microservices.

One such 5G core NF shown operably connected to the base station 112 is the 5G Access and Mobility Management Function (AMF) 110. The AMF is part of the 3GPP 5G Architecture. Its primary tasks include: Registration Management, Connection Management, Reachability Management, Mobility Management and various function relating to security and access management and authorization. Connected to the AMF 110 is the 5G Unified Data Management (UDM) 108 NF. The UDM 108 collects the location information for UE 122 from AMF 110. Connected to the UDM 108 is the home network Home Subscriber Server (HSS)/Home Location Register (HLR) 118 through which the 5G/4G location of UE 122 is able to be obtained by a cellular telecommunication system application server (AS), such as the short message service center (SMSC)/Multimedia Messaging Service Center (MMSC) 102 in operable communication with the HSS/HLR 118. The 4G-MME 116 connected to the HSS/HLR 118 via the S6a interface updates location information during subscriber registration over the S6a interface when the UE 122 is roaming in the mobile network operator coverage area 114.

In an example embodiment, the roaming mobile roaming mobile network operator coverage area 114 may be a cellular network coverage area of a mobile network of a mobile network operator that is a roaming partner to the home mobile network operator that provides home network operator coverage area 112. A roaming partner may be a mobile network operator who provides wholesale cellular wireless services to subscribers of the home mobile network operator based on one or more roaming agreements signed between the home mobile network operator and the roaming partner. For example, UE 122 may be able to use roaming mobile network operator coverage area 114 when moving outside the home mobile network operator coverage area 112 (as shown by arrow 126).

Location updating is the mechanism that is used to determine the location of the UE 122 in the idle state (connected to the network, but with no active call) when it moves from home mobile network operator coverage area 112 to use roaming mobile network operator coverage area 114. When UE 122 is turned on or is transferred via a handover to the roaming mobile network operator coverage area 114, this new “visited” network sees the device, notices that it is not registered with its own system, and attempts to identify its home network. If there is no roaming agreement between the mobile network operator that provides home mobile network operator coverage area 112 and the mobile network operator that provides roaming mobile network operator coverage area 114, maintenance of service is impossible, and service is denied by the mobile network that provides roaming mobile network operator coverage area 114. Otherwise, the mobile network that provides roaming mobile network operator coverage area 114 contacts the mobile network that provides mobile network operator coverage area 112 and requests service information (including whether or not the UE 122 should be allowed to roam) about the roaming UE using the International Mobile Subscriber Identity (IMSI) number. If successful, the mobile network that provides roaming mobile network operator coverage area 114 begins to maintain a temporary subscriber record for UE 122. Likewise, the mobile network that provides mobile network operator coverage area 112 updates its information to indicate that UE 122 is on the mobile network that provides roaming mobile network operator coverage area 114 so that any information sent to UE 122 can be correctly routed.

When 5G first started rolling out around 2018, it was typically built with a 5G radio access network that used a 4G core. This meant 5G could be rolled out without the creation of completely new network infrastructure while still providing higher speeds and improved reliability. This approach is called 5G non-standalone (NSA), and it was a necessary intermediate step as the world transitioned from Fourth Generation (4G) to 5G. In various embodiments, the roaming mobile network operator coverage area 112 may be a coverage area provided by such a 4G or 5G NSA network.

In some embodiments, a 5G SA mobile network operator, such as that which provides home mobile network operator coverage area 112, may still be in the process of expanding 5G SA network coverage, and thus does not yet provide all desired coverage areas. In such instances, the 5G SA mobile network operator providing home mobile network operator coverage area 112 may have a roaming partnership with a mobile network operator that provides a 4G or 5G NSA network coverage area, such as roaming mobile network operator coverage area 114, in order to provided additional coverage for subscribers of the home mobile network operator until the 5G SA network is expanded to include all the desired coverage areas. However, since the mobile network operator that provides roaming mobile network operator coverage area 114 charges the mobile network operator providing home mobile network operator coverage area 112 for text and multimedia messages sent and received by each UE subscribed to the mobile network operator providing home mobile network operator coverage area 112 (e.g., UE 122) while roaming in the roaming mobile network operator coverage area 114, it is important for the mobile network operator providing home mobile network operator coverage area 112 to know when each of its subscriber UEs is roaming and on which network it is roaming, and how many text and multimedia messages were sent and received while roaming. Doing so traditionally required many network hops between various cellular network components and network functions. Described herein is a solution that reduces the number of such network hops.

FIG. 1B is a sequence diagram showing an example sequence of operations 128 for a user equipment (UE) location acquisition mechanism for a 5G subscriber in accordance with embodiments described herein.

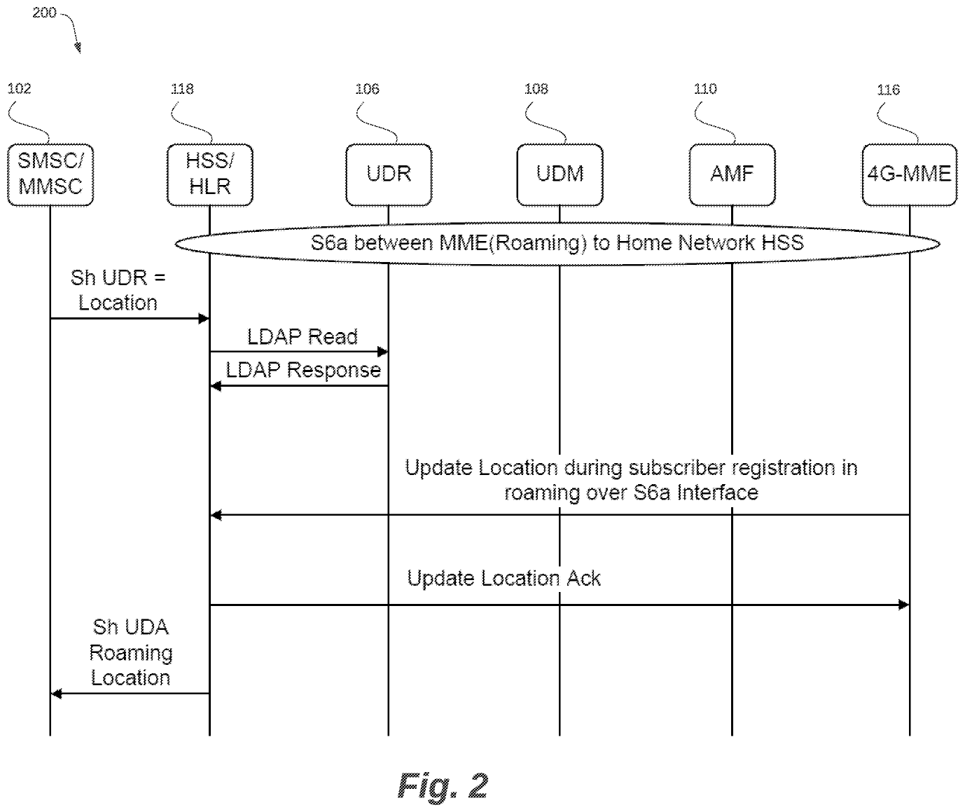

In the example shown in FIG. 1B, a cellular telecommunication system application server (AS), such as a short message service (SMS) center (SMSC) or a Multimedia Messaging Service Center (MMSC) of a 5G cellular network (represented by SMSC/MMSC 102) electronically obtains cellular network subscriber user equipment (UE) location information from a Home Subscriber Server (HSS) of the cellular telecommunication system. The SMSC is the portion of the cellular telecommunication system that handles text message operations. It is responsible for receiving, storing, routing and forwarding SMS messages from UEs. The MMSC is the portion of the cellular telecommunication system that receives, stores, forwards, and delivers multimedia text messages between UEs. The UE, for example, may be a mobile handset such as a cellular telephone or a smartphone, or may be an Internet-of-Things (IoT) device or other cellular enabled device. Overall, the HSS 104 is the main database of the cellular telecommunication system. It contains subscriber-related information, such as the authentication information and the list of services to which each user is subscribed. In particular, the HSS 104 is the unit that manages user profiles, subscriptions and security functions. The HSS 104 is responsible for user authentication when trying to connect to the network and authorization of access to selected services. The HSS 104 also stores information about the subscriber UE's location, the Mobile Management Entity (MME) unit the UE is currently registered with, and the packet networks it can connect to. The HSS 104 operates in contact with the Evolved Packet Core (EPC) in the control plane and communicates with the MME via interface S6a (as shown in FIG. 2).

In the example shown, the AS, such as SMSC/MMSC 102, is able to obtain the UE's 5G/Fourth Generation (4G) location through the HSS 104 in order to support the UE's location-based services which will facilitate the mobile network operator in billing while the UE is on the home cellular network and while the UE is roaming. In the present example embodiment, the SMSC/MMSC 102 requests location information from the HSS 104 with a User-Data-Request (UDR) command using a telecommunication network Sh interface between the SMSC/MMSC 102 and the HSS 104 (Sh UDR=Location) with the parameters Requested Domain: PS, Requested Node: AMF/MME and CurrentLocation: DoNotNeedInitiateActiveLocationRetrieval.

The Sh interface and associated parameters are defined in the 3rd Generation Partnership Project (3GPP) ETSI technical specification ETSI TS 129 329 V15.2.0 (2019-10), which is hereby incorporated by reference in its entirety. The HSS 104 sends a Lightweight Directory Access Protocol (LDAP) Read query to the Unified Data Repository (UDR) 106 (which is not to be confused with the User-Data-Request (UDR) command shown in FIG. 1B) to collect the UE's 3GPP Access and Mobility Management Function (AMF) registration and Short Message Service Function (SMSF) registration information. The UDR 106 is a centralized data repository for subscription data, subscriber policy data, sessions, contexts, and application states. The UDR 106 may provide standard-based Application Programming Interface (API) integrations with other network functions (NFs) to retrieve subscriber subscription and policy data. The UDR 106 stores and manages subscriber identity module (SIM) identities, common subscriber profiles for 4G and 5G subscriptions, and policy data; notifies other NFs of changes in subscriber data; supports REST (real-time) or batch (bulk) SIM provisioning and subscriber data provisioning; and stores and manages service parameters and application data for advanced use cases such as V2X, IoT, and others.

The UDR 106 responds to the LDAP Read query by sending an LDAP Response to the HSS 104 that includes information regarding 3GPP AMF registration, Short Message Service SMSF registration and supported features. The SMSF is the cellular telecommunication system network function responsible for the transmission of SMS messages between users and devices in a 5G cellular network and those in other networks (2G/3G/4G). It interfaces with the SMSC/MMSC 102 via MAP or Diameter SGd interfaces and with the AMF 110 and UDM 108 via N20 and N21 interfaces respectively.

The HSS 104 also uses a Nudm_UECM_IwfCustomerInfo/GetLocInfo operation to retrieve UE location information from the UDM 108. The UDM 108 collects the location information from AMF 110 using an Namf_Location_ProvideLocationInfo operation. The HSS 104 returns an Sh User-Data-Answer (UDA) message to the SMSC/MMSC 102 after the HSS 104 receives the 200 OK (5G Location) response code from 5G network functions UDM 108 and AMF 110, which may be sent along with parameters such as CurrentLoc, Geoinfo, LocaitonAge, RatType, timeZone and SupportedFeature. In an example embodiment, the UDA message includes the following location information parameters and values: NR CellGlobalId, E-UTRANCellGlobalId, TrackingAreaId, GeographicalInfoamtion, AMFAddress, SMSF Address, CurrentLocatoinRetrived, VisitedPLMNID, LocalTimeZone and RATType. This location information is obtained through the HSS 104 in order to support the UE's location-based services and facilitates the mobile network operator in billing while the UE is on the home cellular network and while the UE is roaming.

FIG. 2 is a sequence diagram showing an example sequence of operations 200 for UE location acquisition mechanism for a roaming 5G subscriber in accordance with embodiments described herein.

The system for UE location acquisition in a cellular network supports location-based services of the UE based on UE location information obtained from the HSS while the UE is on a home cellular network and while the UE is roaming. Accordingly, the example sequence of operations 200 shown in FIG. 2 is for UE location acquisition mechanism for a roaming 5G subscriber.

In the example sequence of operations 200 shown in FIG. 2, the AS, such as SMSC/MMSC 102, is able to obtain the UE's 5G/4G location through the HSS/Home Location Register (HLR) 118 in order to support UE's location-based services which will facilitate the mobile network operator in billing while the UE is on the home cellular network and while the UE is roaming. HLR is a database that stores details relating to every cellphone number connected to the Global System for Mobile Communications (GSM) network across the world. In the present example embodiment, the SMSC/MMSC 102 requests location information from the HSS/HLR 118 with a User-Data-Request (UDR) command using a telecommunication network Sh interface between the SMSC/MMSC 102 and the HSS/HLR 118 (Sh UDR=Location) with the parameters Requested Domain: PS, Requested Node: AMF/MME and CurrentLocation: DoNotNeedInitiate ActiveLocationRetrieval.

The HSS/HLR 118 sends an LDAP Read query to the UDR 106 (which is not to be confused with the User-Data-Request (UDR) command shown in FIG. 2) to collect the UE's 3GPP AMF registration and SMSF registration information. The UDR 106 responds to the LDAP Read query by sending an LDAP Response to the HSS 104 that includes information regarding 3GPP AMF registration, Short Message Service SMSF registration and supported features.

The 4G-MME 116 updates location information during subscriber registration when the UE is roaming over the Soa interface. The Soa interface is an long-term evolution (LTE) 4G mobile-related interface between the 4G-MME 116 and the HSS/HLR 118 used for authentication, location and service information about the subscriber. It uses Diameter over Transmission Control Protocol (TCP), User Datagram Protocol (UDP) and Stream Control Transmission Protocol (SCTP) transport protocol. The HSS/HLR 118 then provides an update location acknowledgement to the 4G-MME 116. The HSS/HLR 118 returns an Sh UDA message to the AS (e.g., SMSC/MMSC 102) after the The HSS/HLR 118 receives the 200 OK (5G Location) response code from the roaming network MME (e.g., 4G-MME 116), which may be sent along with parameters such as Evolved Packet System (EPS) location information, Evolved Universal Terrestrial Radio Access Network (E-UTRAN or EURAN) CellGlobalID, TrackingAreaID, MMENAME, CurrentLocationRetrieved, VisitedPLMNID (PMLN Identifier including Mobile Country Code and Mobile Network Code), and International Mobile Subscriber Identity (IMSI). The E-UTRAN Cell Global Identifier (CellGlobalID) is used to identify cells globally. The ECGI is constructed from the MCC (Mobile Country Code), MNC (Mobile Network Code) and the ECI (E-UTRAN Cell Identifier).

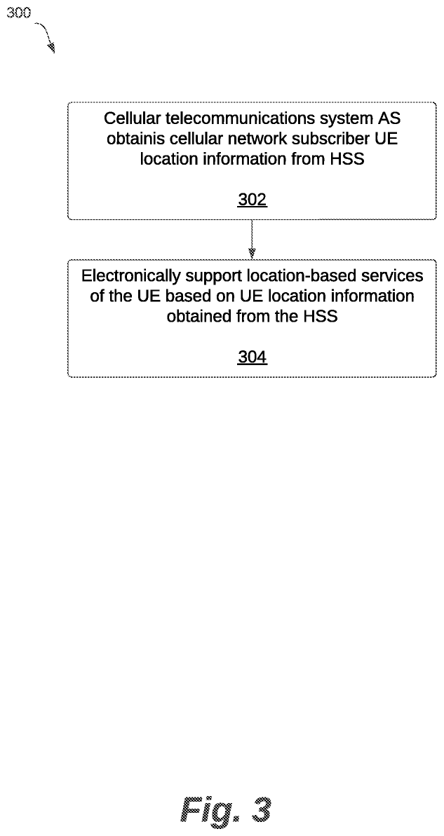

FIG. 3 illustrates a logical flow diagram showing an example embodiment of a process 300 for UE location acquisition in a cellular network in accordance with embodiments described herein.

At 302, a cellular telecommunication system AS electronically obtains a cellular network subscriber UE location information from an HSS of the cellular telecommunication system. In an example embodiment, the AS requests location information from the HSS with a User-Data-Request (UDR) command using a telecommunication network Sh interface between the AS and the HSS. The AS then receives from the HSS a User-Data-Answer UDA message from the HSS including the cellular network subscriber UE location information. The HSS is updated during registration of the subscriber UE by the HSS receiving 5G cellular telecommunications UE location data from a core network of the cellular telecommunication system. For example, this may include the HSS receiving UE location data via a 5G UDM network function and the AMF. This may also or instead include the HSS receiving UE location data via a roaming network MME, and in such instances, the UDA message from the HSS includes a roaming location of the UE. The HSS receiving UE location data via a roaming MME may include the HSS receiving UE location data via an S6a cellular telecommunication interface between the HSS and roaming network MME.

At 302, the cellular telecommunication system (e.g., comprising the items in FIG. 1A, FIG. 1B and FIG. 2) electronically supports location-based services of the UE based on UE location information obtained from the HSS while the UE is on a home cellular network and while the UE is roaming.

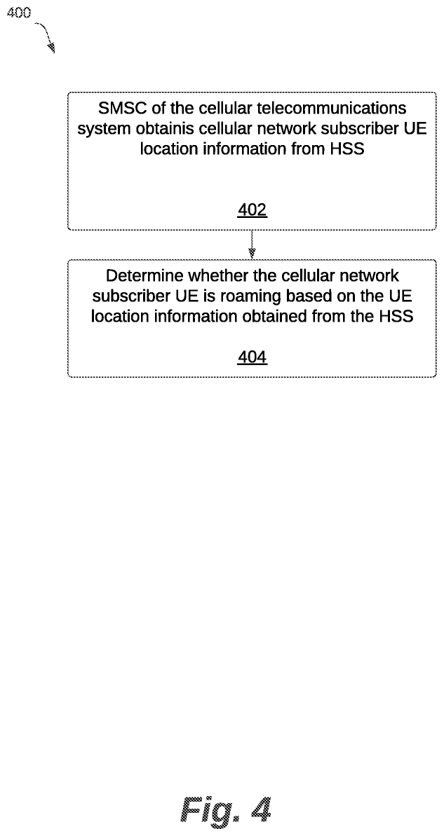

FIG. 4 illustrates a logical flow diagram showing an example embodiment of a process 400 for determining whether the cellular network subscriber UE is roaming based on the UE location information obtained from the HSS in accordance with embodiments described herein.

At 402, the SMSC of the cellular telecommunication system and the MMSC of the cellular telecommunication system obtain cellular network subscriber UE location information from the HSS of the cellular telecommunication system.

At 404, the cellular telecommunication system determines whether the cellular network subscriber UE is roaming based on the UE location information obtained from the HSS.

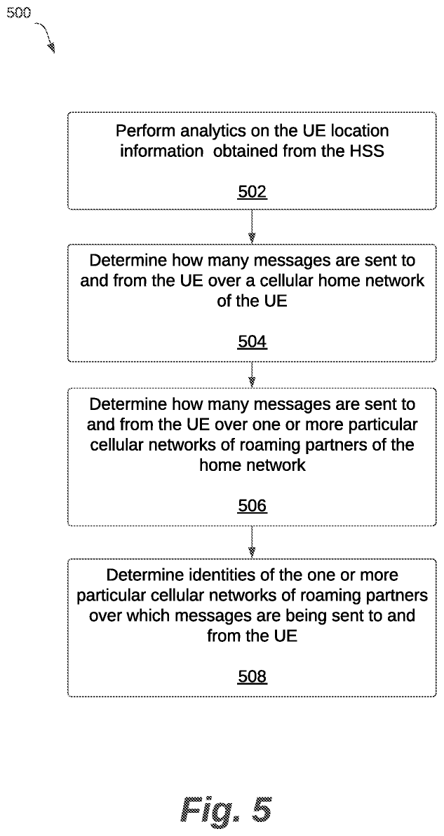

FIG. 5 illustrates a logical flow diagram showing an example embodiment of a process 500 for determining how many messages are sent to and from the UE while roaming and not roaming in accordance with embodiments described herein.

At 502, the cellular telecommunication system electronically performs analytics on the UE location information obtained from the HSS.

At 504, the cellular telecommunication system determines how many messages are sent to and from the UE over a cellular home network of the UE based on the analytics;

At 506, the cellular telecommunication system determines how many messages are sent to and from the UE over one or more particular cellular networks of roaming partners of the home network based on the analytics.

At 508, the cellular telecommunication system determines identities of the one or more particular cellular networks of roaming partners over which messages are being sent to and from the UE based on the analytics.

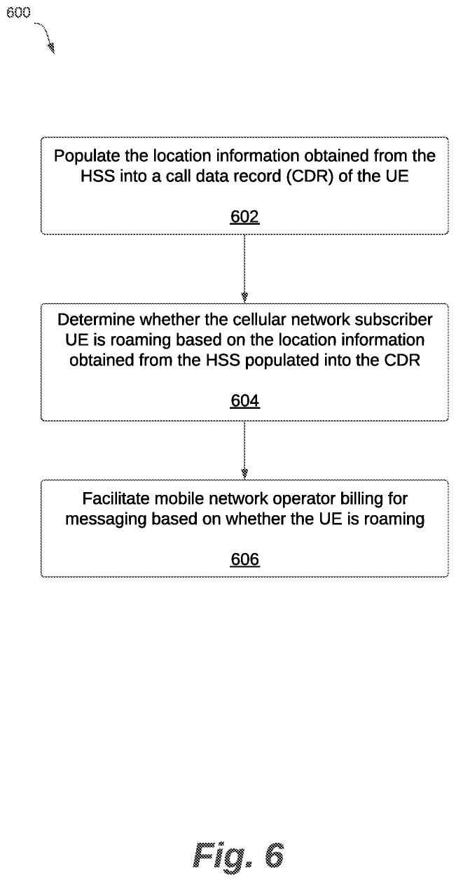

FIG. 6 illustrates a logical flow diagram showing an example embodiment of a process 600 for facilitating mobile network operator billing for messaging based on whether the UE is roaming in accordance with embodiments described herein.

At 602, the cellular telecommunication system populates the location information obtained from the HSS into a call data record (CDR) of the UE.

At 604, the cellular telecommunication system determines whether the cellular network subscriber UE is roaming based on the location information obtained from the HSS populated into the CDR.

At 606, the cellular telecommunication system facilitates mobile network operator billing for messaging based on whether the UE is roaming. In particular, this may be based on whether the UE is roaming using the determination of how many messages are sent to and from the UE over the cellular home network of the UE and the determination of how many messages are sent to and from the UE over one or more particular cellular networks of roaming partners of the home network.

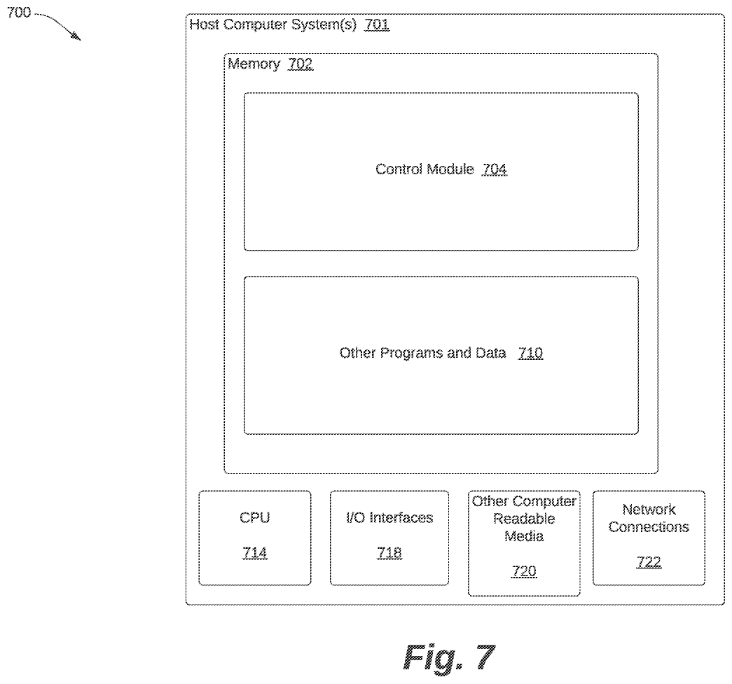

FIG. 7 shows a system diagram 700 that describes an example implementation of computing system(s) for implementing embodiments described herein.

The functionality described herein for UE location acquisition in a cellular network, or components thereof, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they're agnostic to the underlying cloud infrastructure, allowing higher deployment agility and flexibility. However, FIG. 7 illustrates an example of underlying hardware on which such software and functionality may be hosted and/or implemented.

In particular, shown is example host computer system(s) 701. For example, such computer system(s) 701 may represent one or more of those in various data centers, base stations and cell sites that are, or that host or implement the functions of, aspects described herein to implement UE location acquisition in a cellular network. In some embodiments, one or more special-purpose computing systems may be used to implement the functionality described herein. Accordingly, various embodiments described herein may be implemented in software, hardware, firmware, or in some combination thereof. Host computer system(s) 701 may include memory 702, one or more central processing units (CPUs) 714, I/O interfaces 718, other computer-readable media 720, and network connections 722.

Memory 702 may include one or more various types of non-volatile and/or volatile storage technologies. Examples of memory 702 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 702 may be utilized to store information, including computer-readable instructions that are utilized by CPU 714 to perform actions, including those of embodiments described herein.

Memory 702 may have stored thereon control module(s) 704. The control module(s) 704 may be configured to implement and/or perform some or all of the functions of the systems, components and modules described herein to implement UE location acquisition in a cellular network. Memory 702 may also store other programs and data 710, which may include rules, databases, application programming interfaces (APIs), software containers, nodes, pods, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 722 are configured to communicate with other computing devices to facilitate the functionality described herein. In various embodiments, the network connections 722 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 718 may include a video interfaces, other data input or output interfaces, or the like. Other computer-readable media 720 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
a cellular telecommunication system application server (AS) electronically obtaining a cellular network subscriber user equipment (UE) location information from a Home Subscriber Server (HSS) of the cellular telecommunication system; and
electronically supporting location-based services of the UE based on UE location information obtained from the HSS while the UE is on a home cellular network and while the UE is roaming.

2. The method of claim 1 wherein the AS includes one or more of: a short message service center (SMSC) of the cellular telecommunication system and a Multimedia Messaging Service Center (MMSC) of the cellular telecommunication system.

3. The method of claim 1 wherein the electronically supporting location-based services of the UE based on UE location information obtained from the HSS while the UE is on a home cellular network and while the UE is roaming includes determining whether the cellular network subscriber UE is roaming based on the UE location information obtained from the HSS.

4. The method of claim 1, further comprising:
electronically performing analytics on the UE location information obtained from the HSS and the determination whether the UE is roaming to:
determine how many messages are sent to and from the UE over a cellular home network of the UE;
determine how many messages are sent to and from the UE over one or more particular cellular networks of roaming partners of the home network; and
identify the one or more particular cellular networks of roaming partners over which messages are being sent to and from the UE.

5. The method of claim 4, wherein the determining whether the cellular network subscriber UE is roaming based on the UE location information obtained from the HSS includes:
populating the location information obtained from the HSS into a call data record (CDR) of the UE;
determining whether the cellular network subscriber UE is roaming based on the location information obtained from the HSS populated into the CDR.

6. The method of claim 5, further comprising:
facilitating mobile network operator billing for messaging based on whether the UE is roaming using the determination of how many messages are sent to and from the UE over the cellular home network of the UE and the determination of how many messages are sent to and from the UE over one or more particular cellular networks of roaming partners of the home network.

7. The method of claim 1 wherein the AS electronically obtaining the cellular network subscriber UE location information from the HSS includes:
the AS requesting location information from the HSS with a User-Data-Request (UDR) command using a telecommunication network Sh interface between the AS and the HSS; and
receiving from the HSS a User-Data-Answer UDA message from the HSS including the cellular network subscriber UE location information.

8. The method of claim 7 wherein the HSS is updated during registration of the subscriber UE by the HSS receiving Fifth Generation (5G) cellular telecommunications UE location data from a core network of the cellular telecommunication system.

9. The method of claim 8 wherein the HSS receiving UE location data from a core network of the cellular telecommunication system includes the HSS receiving UE location data via a 5G Unified Data Management (UDM) network function and a 5G Access and Mobility Management Function (AMF).

10. The method of claim 8 wherein:
the HSS receiving UE location data from a core network of the cellular telecommunication system includes the HSS receiving UE location data via a roaming network Mobility Management Entity (MME); and
wherein the UDA message from the HSS includes a roaming location of the UE.

11. The method of claim 10 wherein the HSS receiving UE location data via a roaming MME includes the HSS receiving UE location data via an S6a cellular telecommunication interface between the HSS and roaming network MME.

12. A system comprising:
at least one memory that stores computer executable instructions; and
at least one processor that executes the computer executable instructions to cause operations to be performed, the operations including:
a cellular telecommunication system application server (AS) electronically obtaining a cellular network subscriber user equipment (UE) location information from a Home Subscriber Server (HSS) of the cellular telecommunication system; and
electronically supporting location-based services of the UE based on UE location information obtained from the HSS while the UE is on a home cellular network and while the UE is roaming.

13. The system of claim 12, wherein the AS includes one or more of: a short message service center (SMSC) of the cellular telecommunication system and a Multimedia Messaging Service Center (MMSC) of the cellular telecommunication system.

14. The system of claim 12, wherein the electronically supporting location-based services of the UE based on UE location information obtained from the HSS while the UE is on a home cellular network and while the UE is roaming includes determining whether the cellular network subscriber UE is roaming based on the UE location information obtained from the HSS.

15. The system of claim 12, wherein the operations further include:
electronically performing analytics on the UE location information obtained from the HSS and the determination whether the UE is roaming to:
determine how many messages are sent to and from the UE over a cellular home network of the UE;
determine how many messages are sent to and from the UE over one or more particular cellular networks of roaming partners of the home network; and
identify the one or more particular cellular networks of roaming partners over which messages are being sent to and from the UE.

16. The system of claim 15, wherein the determining whether the cellular network subscriber UE is roaming based on the UE location information obtained from the HSS includes:
populating the location information obtained from the HSS into a call data record (CDR) of the UE;
determining whether the cellular network subscriber UE is roaming based on the location information obtained from the HSS populated into the CDR.

17. A non-transitory computer-readable storage medium having computer-executable instructions stored thereon that, when executed by at least one processor, cause the at least one processor to cause operations to be performed, the operations including:
a cellular telecommunication system application server (AS) electronically obtaining a cellular network subscriber user equipment (UE) location information from a Home Subscriber Server (HSS) of the cellular telecommunication system; and
electronically supporting location-based services of the UE based on UE location information obtained from the HSS while the UE is on a home cellular network and while the UE is roaming.

18. The non-transitory computer-readable storage medium of claim 17 wherein the AS includes one or more of: a short message service center (SMSC) of the cellular telecommunication system and a Multimedia Messaging Service Center (MMSC) of the cellular telecommunication system.

19. The non-transitory computer-readable storage medium of claim 17 wherein the electronically supporting location-based services of the UE based on UE location information obtained from the HSS while the UE is on a home cellular network and while the UE is roaming includes determining whether the cellular network subscriber UE is roaming based on the UE location information obtained from the HSS.

20. The non-transitory computer-readable storage medium of claim 17, wherein the operations further include:
electronically performing analytics on the UE location information obtained from the HSS and the determination whether the UE is roaming to:
determine how many messages are sent to and from the UE over a cellular home network of the UE;
determine how many messages are sent to and from the UE over one or more particular cellular networks of roaming partners of the home network; and
identify the one or more particular cellular networks of roaming partners over which messages are being sent to and from the UE.
